(19) United States
(12) Patent Application Publication
(10) Pub. No.: US 2007/0222612 A1
(43) Pub. Date: Sep. 27, 2007

(54) Modular conveyor belt with RFID

(76) Inventor: Michal Krisl, Basel (CH)

Correspondence Address: HODGSON RUSS LLP;THE GUARANTY BUILDING, 140 PEARL STREET, SUITE 100, BUFFALO, NY, 14202-4040, US

(21) Appl. No.: 11/385,153

(22) Filed: Mar. 21, 2006

(51) Int. Cl. G08B 13/14

(52) U.S. Cl. 340/572.8

(57) ABSTRACT

A belt module with an intermediate section, a first plurality of link ends extending from the intermediate section in a direction of belt travel, and a second plurality of link ends extending from the intermediate section in a direction opposite to the first link ends. The first and second plurality of link ends have transverse pivot rod openings defined therein. The second plurality of link ends is offset from the first plurality of link ends such that adjacent belt modules can be intercalated and connected by a pivot rod disposed through the transverse openings. The belt module includes at least one RFID transponder disposed in at least one of the plurality of link ends, the intermediate section, the pivot rod, or an attachment for use with the belt module.

### FIELD OF THE INVENTION

This invention relates to conveyor belts and, more particularly, to modular conveyor belts having at least one radio frequency identification device.

### BACKGROUND OF THE INVENTION

Conveyor belts, particularly modular belts, are widely used to transport goods in production lines, distribution centers and the like. In such premises, it is often necessary and desirable to provide each individual conveyed article with specific information which is needed to correctly pack, label and ship the article to an end user.

To facilitate automatic and efficient information transmission at various positions throughout a conveying system, radio frequency identification devices (RFIDs) may be tagged to the goods, thus providing an ability to identify and track the goods by an external electronic reading device.

One disadvantage of this method is a required tagging of each good being conveyed, the RFID tag being attached directly to or very near the good. Another disadvantage associated with tagging each good is the requirement to either remove each RFID tag so it may be reused or leave the RFID tag attached to the good and lose the tag altogether. If the goods being conveyed are high volume items, the need to attach and later remove or lose the RFID tag may have high labor and/or resource requirements.

Another circumstance where RFID tags may be utilized is in a tracking or monitoring of information relating to the conveyor belt itself. Such information may be utilized to correctly identify each conveyor system, track characteristics or properties of each conveyor system and control cleaning cycles for or maintenance information relating to the conveyor system. Until the present, such information has been maintained on disparate systems, such as logbooks, offline computer systems and the like.

### SUMMARY OF THE INVENTION

In order to eliminate the above shortcomings, a new system for integrated identification on conveyor belts is proposed. RFID tags may be attached to or implanted within the belt module or pivot rod, thus serving to identify a conveyed item on a conveyor belt without a need to attach the RFID tag to the conveyed item itself. Additionally, when the conveyed item is offloaded from the conveyor belt, information contained in or associated with the RFID tag and/or to the conveyed item may be erased or reset such that the RFID may be capable of being reused. Additionally, the RFID tag may be used for identification of the conveyor belt itself, providing various information such as, but not limited to, belt type, product line and lifetime maintenance cycles.

In one embodiment of the invention, RFID tags may be coupled to a belt module by preparing small cavities in the belt module or pivot rod. The RFID tag may then be inserted and fixed in the cavity.

In an alternative embodiment of the invention, RFID tags may be directly molded into the belt module in such a way that the RFID tags may be completely covered by the module body and protected against fluid and mechanical contact. This embodiment may be suitable to the fabrication of belt modules with integral RFID tags as many belt modules are injection molded. By utilizing this technique, one or more RFID tags may be positioned anywhere within the belt module, such as, but not limited to, below the belt, in a link pin, within link ends, near the edges of the module or under the conveying surface. Another advantage of molding the RFID tag integral with the belt module is that the RFID tag may not be easily lost, damaged or tampered with.

Conveyor belt modules may be assembled to meet any requirement, purpose or cost. Typically, belt modules containing RFID tags may be limited to a number necessary to provide maximum information at a minimum of cost. In one embodiment, belt modules containing RFID tags may be introduced at various positions throughout the conveyor belt to denote information such as, but not limited to, item types, temperature, humidity, pressure, tension, item location or belt measurement. In another embodiment, belt modules having RFID tags may comprise every or nearly every belt module of the conveyor system. This configuration may provide similar information as listed above with finer resolution.

The present invention meets the above-described need by providing a belt module with a base portion having a first end, a second end, and an intermediate section extending in a transverse direction from the first end to the second end. The module includes a first plurality of link ends extending from the intermediate section in a direction of belt travel substantially perpendicular to the transverse direction. Each of the first plurality of link ends has first openings that are aligned in the transverse direction. The module includes a second plurality of link ends extending from the intermediate section in a direction opposite to the first link ends. The second plurality of link ends each have second openings aligned in the transverse direction. The module has at least one RFID tag embedded within or attached to the module.

### BRIEF DESCRIPTION OF THE DRAWINGS

The invention is illustrated in the drawings in which like reference characters designate the same or similar parts throughout the figures of which:

FIG. 1 is a top plan view of a section of a belt module with RFID devices;

FIG. 2 is a side cross-sectional view taken along line 2-2 of FIG. 1;

FIG. 3 is a side view of a pivot rod with at least one RFID device implanted in various locations throughout the pivot rod;

FIGS. 4A to 4C show a diagrammatic section through an injection molding apparatus suitable for manufacturing a module for a modular conveyor belt according to the present invention;

FIG. 5 is a top plan view of a flush grid belt module;

FIG. 6 is a bottom plan view of the module shown in FIG. 5;

FIG. 7A is a side elevation view showing a snap-on hold down tab in an exploded view;

FIG. 7B is a side elevation view showing the snap-on hold down tab installed in the module;

FIG. 8 is a perspective view of a module with snap-on side guards having RFID tags; and,

FIG. 9 is a perspective view of a module with flights containing RFID tags.

### DETAILED DESCRIPTION OF THE INVENTION

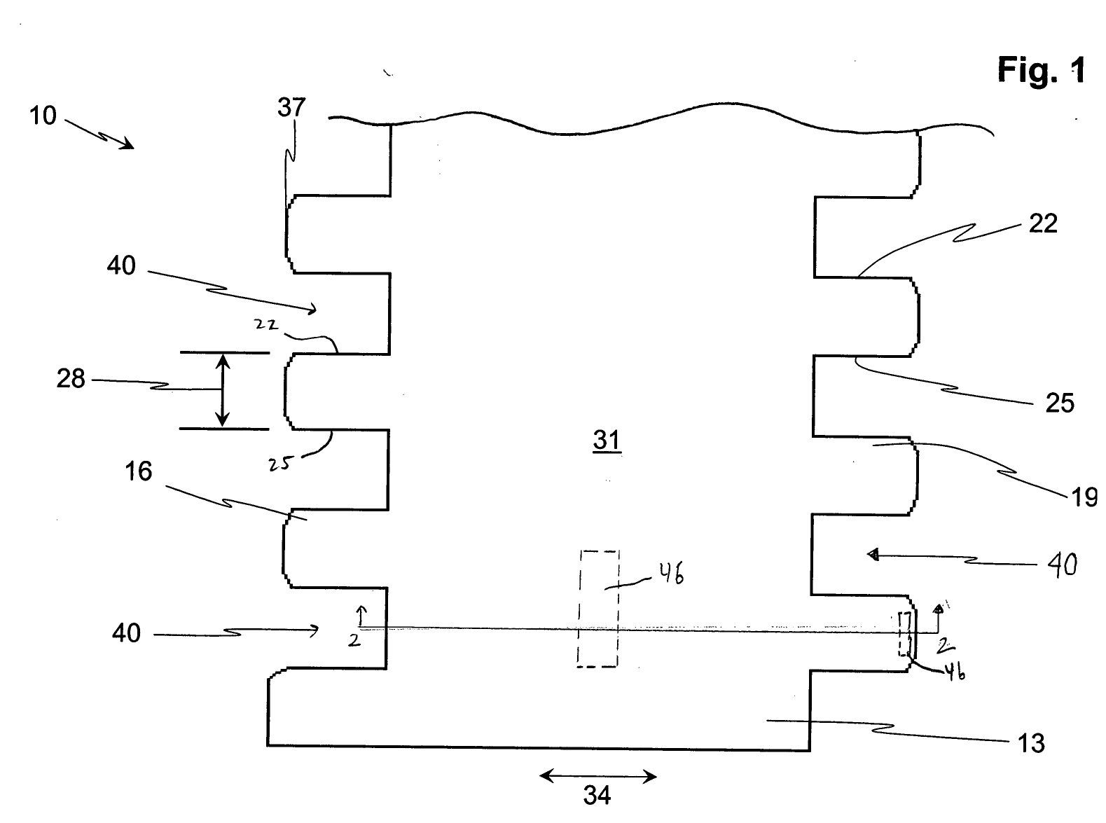

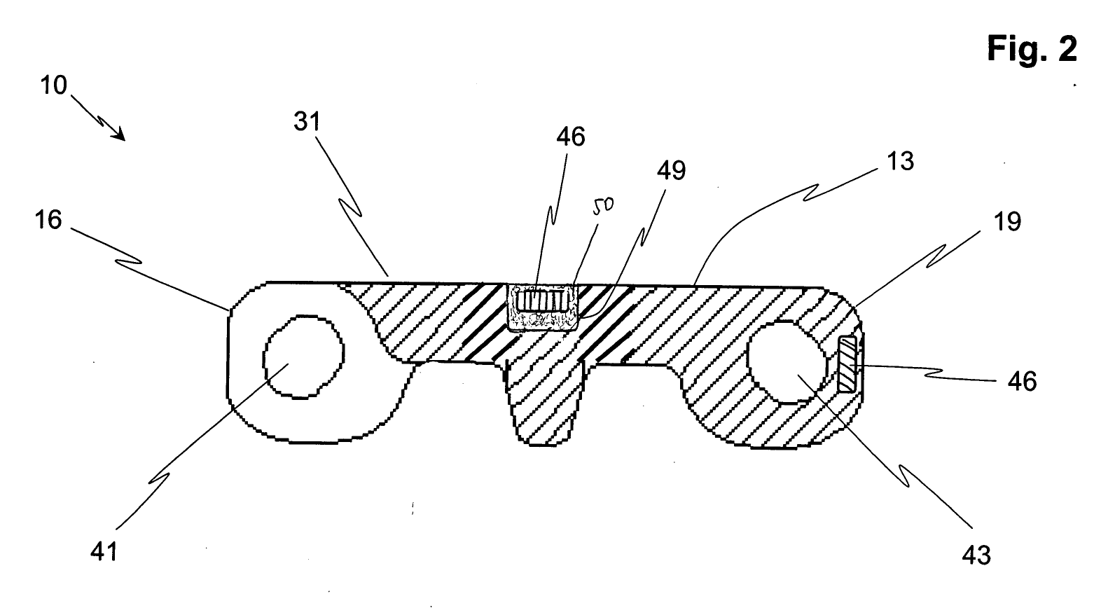

Referring to FIGS. 1-3 generally and initially to FIGS. 1 and 2, the belt module 10 of the present invention includes a top surface 13. The module 10 has a first plurality of link ends 16 and a second plurality of link ends 19 disposed opposite from the first link ends 16. The first plurality of link ends 16 have opposed side walls 22, 25 that provide a transverse thickness 28 connected to an intermediate section 31 which has a top surface 13 that may be substantially rectangular in plan view. The transverse thickness 28 extends in a direction of belt travel 34 from the intermediate section 31 to a first distal portion 37. The second plurality of link ends 19 have similar geometry except they extend opposite to the first plurality of link ends 16 in the direction of belt travel indicated by arrow 34. As will be evident to those of ordinary skill in the art based on this disclosure, the belt module 10 may be driven in either direction along arrow 34.

The link ends 16 and 19 are offset in a direction transverse to the direction of belt travel 34. Accordingly, adjacent modules 10 can be positioned such that the link ends 16 fit in the spaces 40 disposed between link ends 19, and link ends 19 fit in the spaces 40 disposed between link ends 16. The link ends 16, 19 have transverse openings 41 and 43 (FIG. 2) that extend through the transverse thickness 28 between and to the opposed side walls 22, 25. As will be evident to those of ordinary skill in the art, modules 10 can be positioned such that link ends 16 and 19 are intercalated with the link ends 16 and 19 of an adjacent module 10. The side-by-side and intercalated modules 10 can then be connected by pivot rods to provide an endless belt capable of articulating about a sprocket to form a conveying system.

Module 10 may be formed out of plastic or other materials suitable for many applications including conveying of food products. The material may be lightweight, non-corrosive, and easily cleaned. The module 10 may be thermoformed from a plastic resin raw material as known to those of ordinary skill in the art.

As shown in FIGS. 1 and 2, the RFID tags 46 may be disposed on the module 10 in many locations including, but not limited to, the link ends 16, 19; the intermediate section 31; or the like.

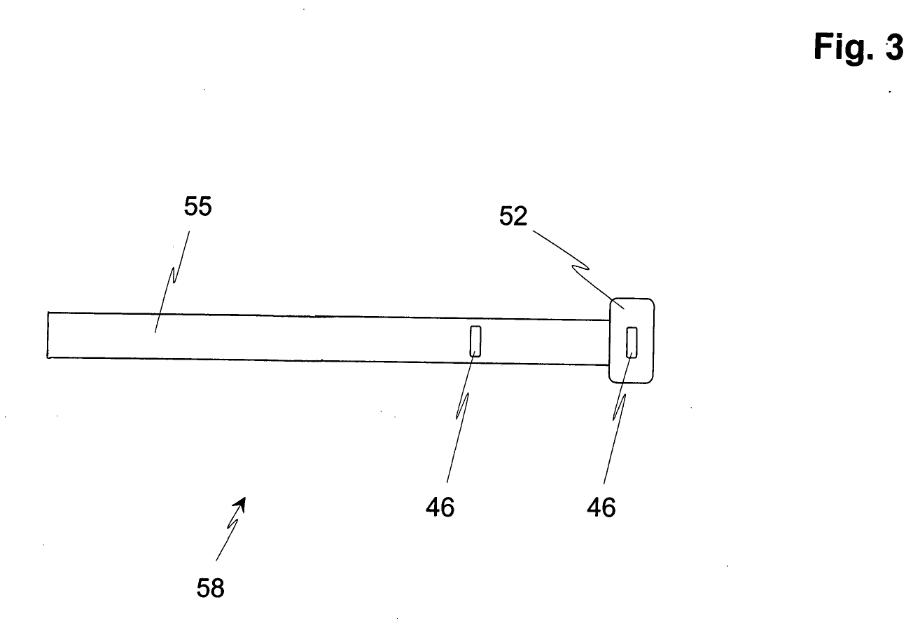

In another embodiment of the invention shown in FIG. 3, RFID tags 46 may be integrated into a head 52 or a shaft 55 of a pivot rod 58. The integration can be performed by insertion into a machined or pre-molded cavity or by a molding process. Because the pivot rods are very versatile and can be used to assemble various types of modular belts for different applications, it is possible to produce a series of such rods equipped with RFID's and to keep the rods in stock to be used for assembly of a customized belt where needed. The RFID may be integrated in any location of the rod, but preferably near one end or both ends of the rod. Rods with RFID's can then be installed in each link or in every second, third, etc. link or in any greater distance. If there is a defect, the pivot rod can be easily and inexpensively replaced.

The RFID tags 46 may be integrated into the module 10 in a variety of ways. Returning to FIG. 2, in one embodiment of the present invention, a recess 49 may be formed in the module 10 by drilling or machining such that the recess 49 is capable of receiving an RFID tag 46. The RFID tag 46 may be secured in the recess 49 by filling the recess 49 with a cross-linked or hot melt adhesive 50.

In an alternative embodiment of the invention, RFID tags 46 may be directly molded into the module 10 in such a way that the RFID tags 46 may be completely covered by the module 10 and protected against fluid and mechanical contact. This embodiment may be suitable to the fabrication of belt modules with integral RFID tags 46 as many belt modules 10 are injection molded. RFID tags suitable for injection molding may be obtained from UPM Rafsec of Tampere, Finland and other sources. By utilizing this technique, one or more RFID tags 46 may be positioned anywhere within the module 10, such as, but not limited to, below the module 10, in a pivot rod 58, within link ends 16, 19, near the edges of the module or under the conveying surface. Another advantage of molding the RFID tag 46 integral with the module 10 is that the RFID tag 46 may not be easily lost, damaged or tampered with.

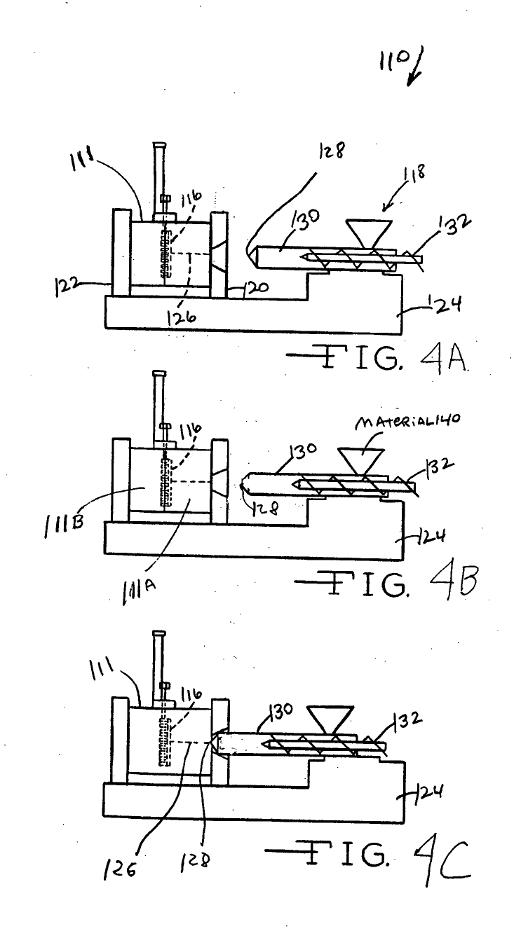

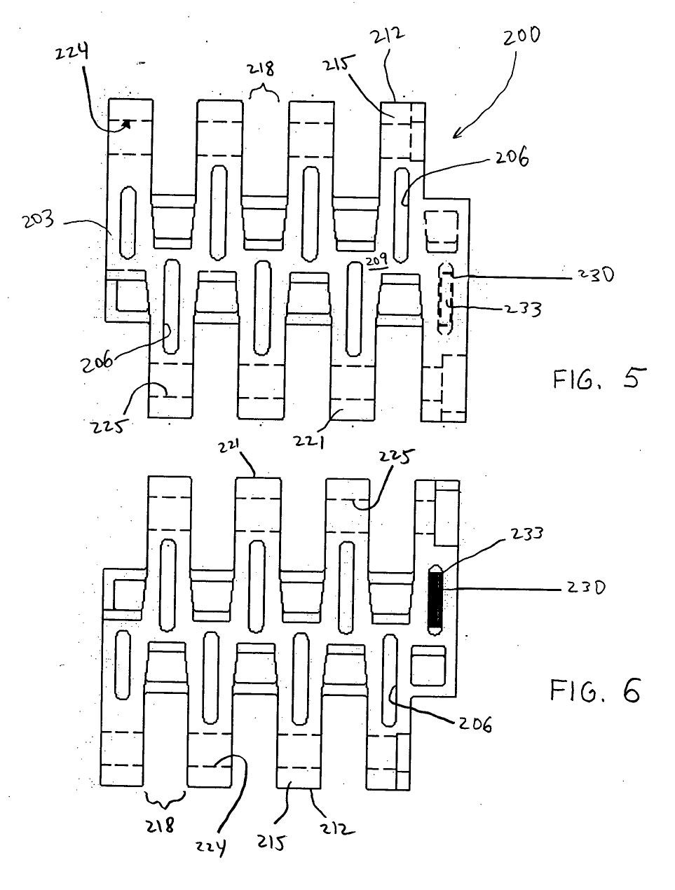

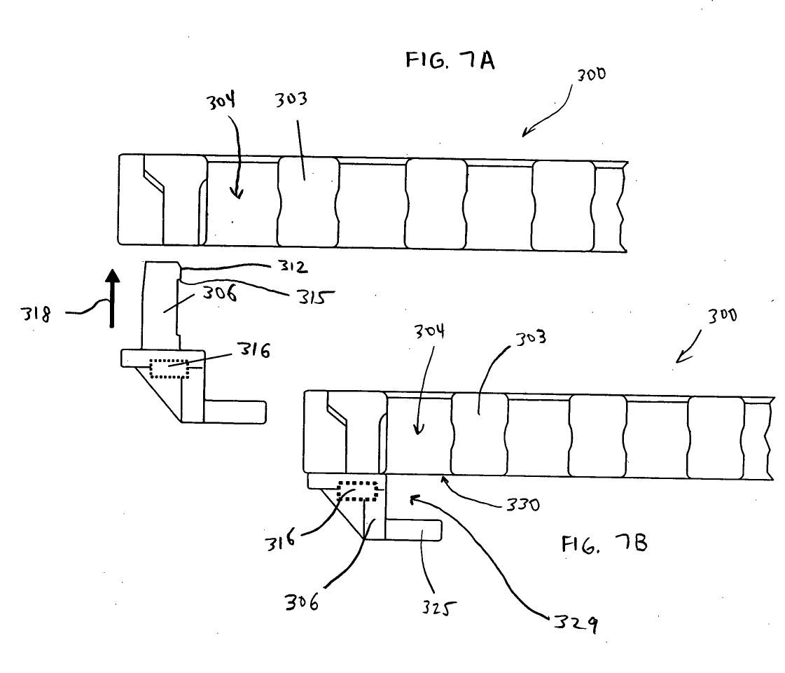

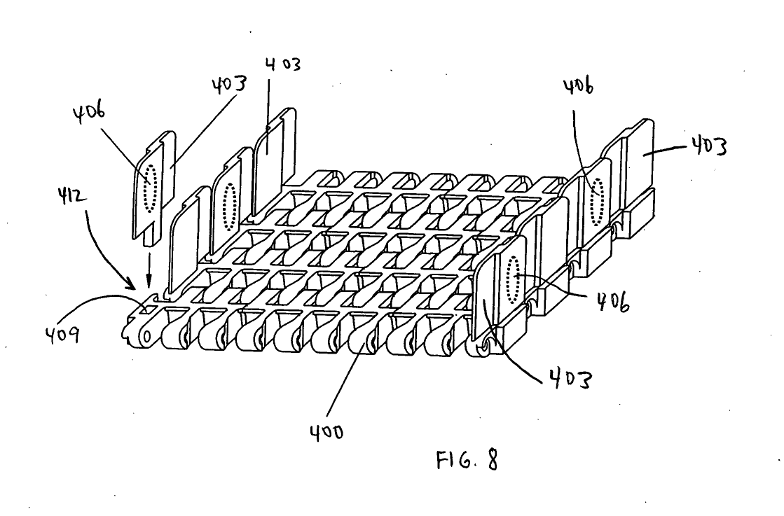

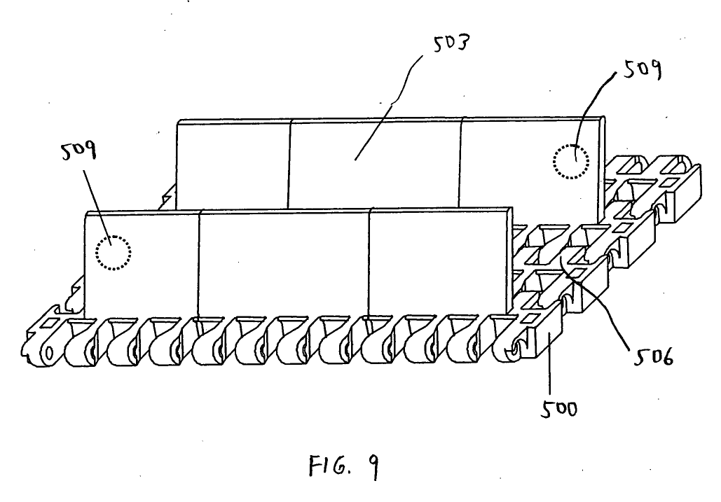

FIGS. 4A to 4C show a molding apparatus 110 including a mold 111 for making a module for a modular conveyor belt according to the present invention. The mold 111 for producing the modules 10 includes first and second mating mold halves 111A, 111B forming a mold cavity 116 for receiving a plastic melt from an injection unit 118. The mating mold halves 111A, 111B are mounted on a stationary platen 120 and a moving platen 122, respectively. The stationary platen 120, moving platen 122 and injection unit 118 are supported by a common base 124. The mold 111 includes a sprue channel 126 through the first mold half 111A which is in fluid flow communication with a nozzle 128 on the injection unit 118 when material is injected into the mold cavity 116. The nozzle 128 is equipped with a shut-off valve (not shown) of the type that is well known in the art.

The injection unit 118 has a barrel 130 which includes a feed screw 132 of a configuration that is typical for injection molding. The feed screw is controlled to reciprocate in the barrel 130 to plasticize and inject plastic into the mold 111. The injection unit 118 is equipped with means, such as a hydraulic cylinder (not shown) to move the unit 118 linearly toward and away from the mold 111. More specifically, the injection unit 118 is moved against the mold 111 for injection, then is retracted away from the mold 111 and stationary platen 120.

A cycle of operation for the production of a module made by a molding method according to the present invention will now be described with respect to FIGS. 4A to 4C. The injection unit 118 is retracted to a rearward position (FIG. 4A), that provides clearance between the stationary platen 120 and the nozzle 128. The injection unit 118 plasticizes a sufficient quantity of the material 140 by rotating and retracting the feed screw 132 in a conventional manner so a full shot of melt is prepared.

An RFID tag is placed inside the dedicated cavity 116 of the mold 111. The RFID tag is kept in position by a mechanical holder or by a vacuum device as will be evident to those of ordinary skill in the art based on this disclosure.

The injection unit 118 moves forward to a position where the nozzle 128 communicates with the sprue channel 126 of the mold 111. As shown in FIG. 4C, the injection unit 118 then injects the polymeric material into the mold 111 by advancing the feed screw 132 in a manner typical of the injection molding process. The injected plastics surround the RFID tag while filling the cavity 116. If present, the mechanical holder is withdrawn before the full freezing of the plastic. After cooling, the two mold halves open and the piece, with the RFID tag embedded, can be removed. As will be evident to those of ordinary skill in the art based on this disclosure, mold 116 may be shaped to form a module 10 or other shape such as a pivot rod 58.

Turning to FIGS. 5 and 6, one example of the present invention is shown in connection with a flush grid belt module 200. In FIG. 5, the upper conveying surface 203 is shown. Vertical openings 206 are disposed on the module 200 and may extend from the intermediate section 209 toward the distal end 212 of the link ends 215. The link ends 215 are separated by spaces 218 that receive link ends 221 on adjacent modules. Each link end 215 has a transverse pivot rod opening 224 capable of aligning with transverse pivot rod openings 225 on intercalated link ends 221. Insertion of the pivot rod (not shown) connects adjacent modules 200 to form an endless belt capable of articulating about a sprocket. A cavity 230 may be formed at any suitable location on the module 200. In the example shown, the cavity 230 is located near the edge of module 200. The cavity 230 may be produced in many ways such as by drilling, milling, pre-molding, or the like. An RFID tag 233 is inserted into the cavity 230 and held in position by mechanical means such as a friction fit, engagement with protuberances inside the cavity 230, or the like. Other means for securing the RFID tag 233 such as cross-linked or hot melt adhesives, or the like, may also be suitable.

Another embodiment of the invention is shown in FIG. 7A. A module 300 has link ends 303 with spaces 304 disposed therebetween for receiving link ends from an adjacent module. The module 300 includes a snap-on hold down tab 306. The hold down tab 306 engages with an opening in the module 300 located near the edge 309. The tab 306 has a protruding portion 312 that forms a shoulder 315. The tab 306 can be pushed in the direction of arrow 318 until it snaps into place in the opening in the end of the module 300. An RFID tag 316 is disposed on the tab 306. As described above in connection with other embodiments, the RFID tag 316 may be integrated into the tab 306 in a variety of ways. A recess may be formed by drilling, milling, pre-molding or the like. The RFID tag 316 may be secured in the recess by adhesives or the like or by mechanical means. Also, the RFID tag 316 may be integrally molded as described above.

As shown in FIG. 7B, after it is attached to the module 300, the hold down tab 306 has a projection 325 that extends substantially parallel to the conveying surface 328. The projection 325 engages with a guide (not shown) that fits into the space 329 between the bottom surface 330 of the module 300 and the projection 325.

In FIG. 8, a module 400 is shown with snap-on side guards 403 having RFID tags 406 disposed thereon. The side guards 403 fit into openings 409 located near the edge 412 of the module 400. The RFID tag 406 may be integrated into the side guard 403 by means of a recess or by being molded integrally as described above.

Turning to FIG. 9, a module 500 is shown with flights 503 that extend upward from the conveying surface 506. Flights 503 may be formed integrally with the module 500 during the injection molding process. Alternatively, the flights may be formed from a separate component that is attached to the module. The flights may be formed separately from similar materials to the module such as a hard plastic or the flights may be formed from softer, resilient materials. The separate flights may be attached to the modules in various ways as will be evident to those of ordinary skill in the art based on this disclosure.

The flights 503 may be provided with RFID tags 509. As discussed previously, the RFID tags 509 may be integrated into the flights 503 by means of recesses formed in the flights or by co-molding the RFID tags 509 into the modules 500 as an integral part of the flights 503.

While the invention has been described in connection with certain embodiments, it is not intended to limit the scope of the invention to the particular forms set forth, but, on the contrary, it is intended to cover such alternatives, modifications, and equivalents as may be included within the spirit and scope of the invention as defined by the appended claims.

What is claimed is:

1. A belt module comprising:
a body having an intermediate section, the body having a first plurality of link ends extending from the intermediate section in a direction of belt travel, the first plurality of link ends each having first transverse pivot rod openings defined therein, the body having a second plurality of link ends extending from the intermediate section in a direction opposite to the first link ends, the second plurality of link ends each having second transverse pivot rod openings defined therein, the second plurality of link ends being offset from the first plurality of link ends such that adjacent belt modules can be intercalated; and
at least one RFID transponder disposed on the module.

2. The belt module of claim 1 wherein the RFID transponder is capable of receiving a signal.

3. The belt module of claim 1 wherein the RFID transponder is capable of transmitting a signal.

4. The belt module of claim 1, wherein the RFID transponder is disposed inside a bore formed in the body.

5. The belt module of claim 1, wherein the RFID transponder is molded integrally into the body.

6. The belt module of claim 1, further comprising a flight extending from the intermediate section.

7. The belt module of claim 6, wherein the RFID transponder is disposed on the flight.

8. The belt module of claim 1, wherein the body has at least one opening for receiving an attachment.

9. The belt module of claim 8, wherein the RFID transponder is disposed on the attachment.

10. The belt module of claim 9, wherein the attachment comprises a side guard.

11. The belt module of claim 9, wherein the attachment comprises a hold down tab.

12. A belt module comprising:
an intermediate section;
a first plurality of link ends extending from the intermediate section in a direction of belt travel, the first plurality of link ends each having first transverse pivot rod openings defined therein;
a second plurality of link ends extending from the intermediate section in a direction opposite to the first link ends, the second plurality of link ends each having second transverse pivot rod openings defined therein, the second plurality of link ends being offset from the first plurality of link ends such that adjacent belt modules can be intercalated; and
at least one RFID transponder disposed on the intermediate section.

13. The belt module of claim 12 wherein the RFID transponder is capable of receiving a signal.

14. The belt module of claim 12 wherein the RFID transponder is capable of transmitting a signal.

15. The belt module of claim 12, wherein the RFID transponder is disposed inside a bore formed in the intermediate section.

16. The belt module of claim 12, wherein the RFID transponder is molded integrally into the intermediate section.

17. A modular belt system including:
a plurality of belt modules having an intermediate section and having a plurality of first link ends extending outwardly from the intermediate section in the direction of belt travel and having a plurality of second link ends extending outwardly from the intermediate section in the opposite direction, the first and second link ends having transverse pivot rod openings defined therein; and,
a pivot rod extending transverse to the direction of belt travel through the openings in the first link ends of one of the plurality of belt modules and extending through the openings in the second link ends of an adjacent belt module such that the first and second link ends of the adjacent belt modules are intercalated into adjacent hinged rows, the pivot rod having at least one RFID transponder therein.

18. The modular belt system of claim 17 wherein the RFID transponder is capable of receiving a signal.

19. The modular belt system of claim 17 wherein the RFID transponder is capable of transmitting a signal.

20. The belt module of claim 17, wherein the RFID transponder is disposed inside a bore formed in the pivot rod.

21. The belt module of claim 17, wherein the RFID transponder is molded integrally into the pivot rod.

22. A method for providing a module for a modular conveyor belt, comprising:
providing a molding apparatus having an injection unit with a barrel housing a feed screw;
providing a mold with a cavity configured to the shape of the module being produced;
positioning at least one RFID transponder in the cavity;
connecting the barrel with the mold and actuating the feed screw so that the polymeric material is injected into the mold around the RFID transponder; and,
removing the module from the mold, the module comprising a first plurality of link ends, a second plurality of link ends and an intermediate section integrally formed with and adjoining the first and second plurality of link end, wherein the polymeric material surrounds the RFID transponder.

23. A method for providing a pivot rod for a modular conveyor belt, comprising:
providing a molding apparatus having an injection unit with a barrel housing a feed screw;
providing a mold with a cavity configured to the shape of the pivot rod being produced;
positioning at least one RFID transponder in the cavity;
connecting the barrel with the mold and actuating the feed screw so that the polymeric material is injected into the mold around the RFID transponder; and,
removing the pivot rod from the mold, the pivot rod being formed such that the polymeric material surrounds the RFID transponder.

24. A method for providing an attachment for a modular conveyor belt, comprising:
providing a molding apparatus having an injection unit with a barrel housing a feed screw;
providing a mold with a cavity configured to the shape of the attachment being produced;
positioning at least one RFID transponder in the cavity;
connecting the barrel with the mold and actuating the feed screw so that the polymeric material is injected into the mold around the RFID transponder; and,
removing the attachment from the mold, the attachment being formed such that the polymeric material surrounds the RFID transponder.

25. The method of claim 24, wherein the attachment comprises a side guard.

26. The method of claim 24, wherein the attachment comprises a hold down tab.
